(19) United States
(12) Patent Application Publication
(10) Pub. No.: US 2024/0123900 A1
(43) Pub. Date: Apr. 18, 2024

(54) WIRELESS REMOTE CONTROL U-TURN SIGNAL SYSTEM

(71) Applicant: Benjamin Brewster, SR., Palmdale, CA (US)

(72) Inventor: Benjamin Brewster, SR., Palmdale, CA (US)

(21) Appl. No.: 15/961,040

(22) Filed: Jun. 1, 2018

(51) Int. Cl. B60Q 1/50

(52) U.S. Cl. CPC B60Q 1/547; B60Q 2900/30

(57) ABSTRACT

The Wireless Remote-Control U-turn Signal System is the first invention of its kind and will be the first realistic method of acknowledging a motorist making a U-turn at intersections. It works like the Right slash Left Turn Signals installed on all motored vehicles, it will illuminate the intersections with the hopes of alerting surrounding motorist and pedestrians of the motorist intended direction. And my Wireless Remote Control U-turn Signals shape like a “U.”

### BACKGROUND OF THE INVENTION

### 1. Field of the Invention

The Wireless Remote-Control U-turn Signal System relates to the Right and Left Turn Signals on all motored vehicles.

### 2. Description of the Previous Art

I conduct a Patent search, according to the United States Patent Trade Office, I found five results using the Patent Application Full Text and Image Database on Apr. 22, 2014 and Patent Search on Apr. 17, 2018. After reviewing all five results, I realized that there is no apparatus to date, which compares to my Wireless Remote-Control U-turn Signal System. Moreover, I will point out the flaws in all 5 Patent Applications mentioned below and how my Wireless Remote-Control U-turn Signal System is more realistic and suitable for Old and New Automobiles.

Referring to Patent Application Publication/Apr. 3, 2014/Sheet 2 thru 5/U.S. 2014/00091920 A1: After reviewing FIG. 2A, I notice the design cause for an installer to drill three screws through an already patented plastic Headlight Lens Cover, which varies in shapes and sizes depending on the make of the vehicle. Moreover, if the motorist has monthly payments, the motorist cannot make alterations to the Vehicle until the Pink Slip is paid-in-full.

In addition, the car manufacture designed the Headlight Lens to fit the vehicle's Aero Dynamics, and I believe the looks of FIG. 2B will take away from the Aerodynamics. Because the design bevels out to far, which will cause the Aerodynamics to flow in a negative direction and wind deflection in the inside of the “U” design.

Notice in FIG. 2B-264B, will need a nice size drill bit to drill through the Headlight Housing.

Look at FIG. 2C-27B, a fourth hole needs drilling to run 27B Wire through the hole number 4, and where will that wire connect itself to after running the wire through hole.

FIG. 2D reveals the same flaws as FIG. 2A, FIG. 2B and FIG. 2C. The installer will have to be careful when drilling, not to crack the Headlight Lens Cover and the Headlight Housing when attempting to install the apparatus belonging to Patent Application 201400091920.

Referring to Patent Application Publication/Jun, 14, 2007/sheet 1 thru 5/U.S. 2007/0132573 A1: After reviewing FIG. 1 is extremely hard to figure out when attempting to install the apparatus, unless it is part of the design, and before the vehicle is assemble on an Assembly Line. FIG. 7 and FIG. 8 reveals the fact that the manufactures must change their wiring diagrams, their Right and Left turn switch on the steering column and many other things when attempting to install the apparatus belonging to Patent Application 20070132573.

Referring to Patent Application Publication/Oct. 27, 2005/sheet 1 thru 6/U.S. 2005/0237174 A1: After reviewing FIG. 1 looks like a Lens Cover Protector and FIG. 2 reminds me of a window being install in a 4-wheel drive truck. FIG. 4 reminds me of a stylish License Plate Cover with lights or a window shield Weather Strip Protector and the illumination remains me of speakers with the LED lighting that reacts to beats coming from the speakers and not a U-turn Signal when looking at the apparatus belonging to Patent Application 20050237174.

Referring to Patent Application Publication/Aug. 18, 2005/sheet 1 thru 4/U.S. 2005/0179533 A1: After reviewing drawing on sheet 2 of 4, it reminds me of a Lens Cover with an inverted “U” design on the lens cover instead of an Automobile U-turn Signal. Sheet 3 of 4 suggest the changing of the Right and Left Turn Signal Switch, and the wiring diagram. Moreover, I do not see a U-turn Signal, I see an inverted “U” design on the lens cover and not a U-turn Signal when looking at the apparatus belonging to Patent Application 20050179533.

Referring to Patent Application Publication/Aug. 4, 2005/sheet 1 thru 3/U.S. 2005/0168347 A1: After reviewing FIG. 1 reminds me of an unrealistic approach to design U-turn Signals for motored vehicles. FIGS. 5 thru 9 reminds me of road construction signs used by Caltrans workers and not a U-turn Signal when looking at the apparatus belonging to Patent Application 20050168347.

### BRIEF SUMMARY OF THE INVENTION

The Wireless Remote-Control U-turn Signal System relates to no existing or partially existing inventions related to U-turns Signal for automobiles according to the USPTO Patent Full-Text and Image Database on Mar. 10, 2018.

The Wireless Remote-Control U-turn Signal System is comprised of 1-Wireless Signal-pod and 4-U-turn Signals.

The Wireless Remote-Control U-turn Signal System when activated, it will illuminate the intersections like Right and Left turn signals on all Motor Vehicles.

The Wireless Remote-Control U-turn Signal System use the same materials used to make Wireless Signals Lights we see on Bicycles.

### BRIEF DESCRIPTION OF THE SEVERAL VIEWS OF THE DRAWING

To simplify the functions for the Wireless Remote Control U-turn Signal System for Motor Vehicles, I will reference the appending drawings.

FIG. 1A diagram of the component's needed to assemble the U-TURN SIGNALS for the Inside Front and Back Windows for all Motor Vehicles.

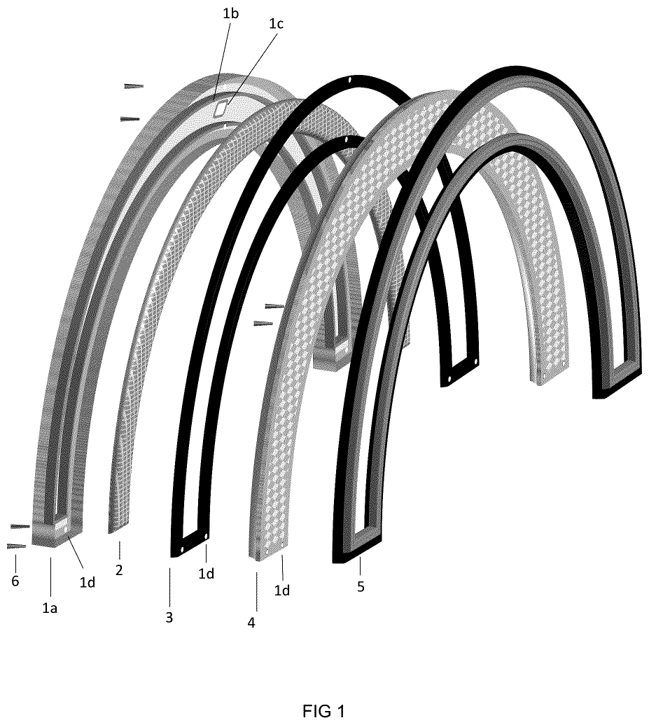

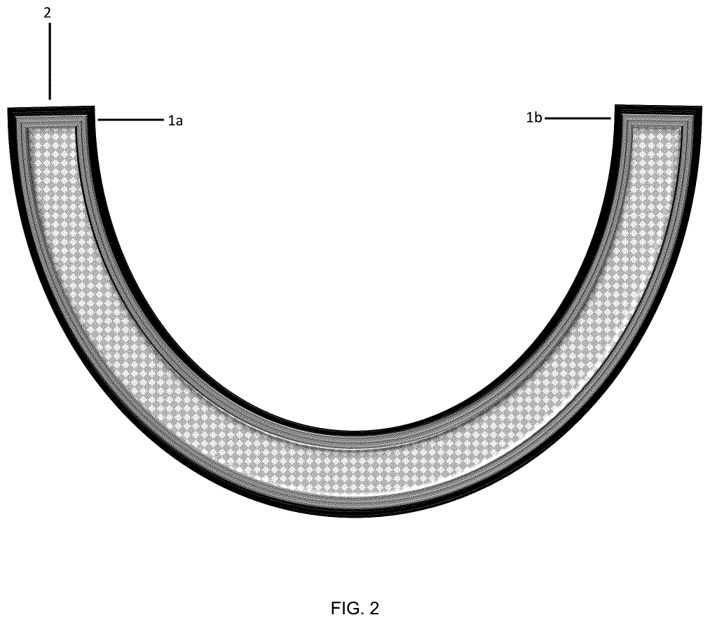

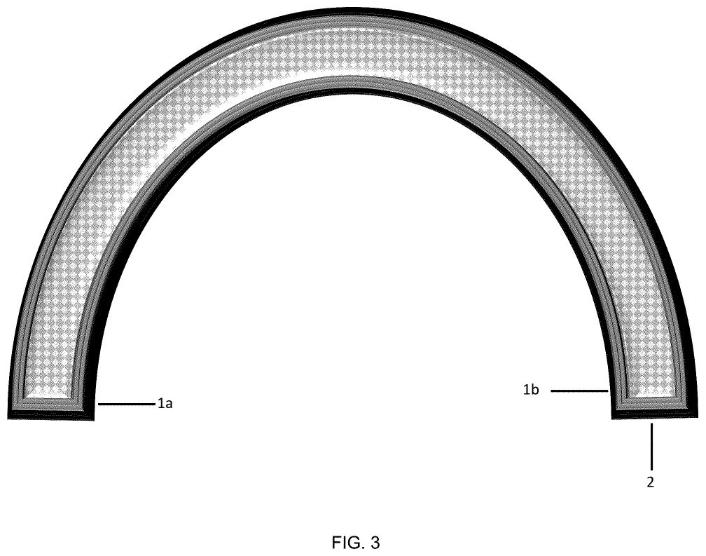

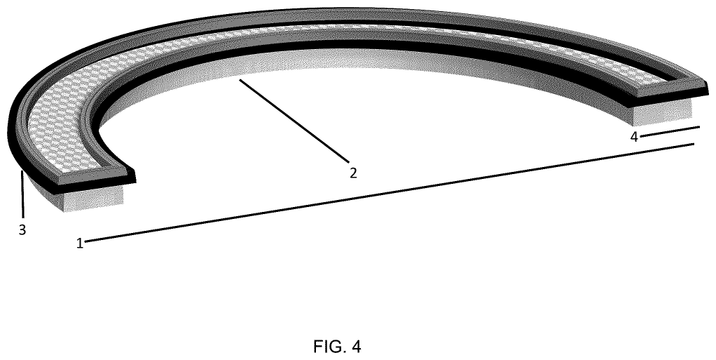

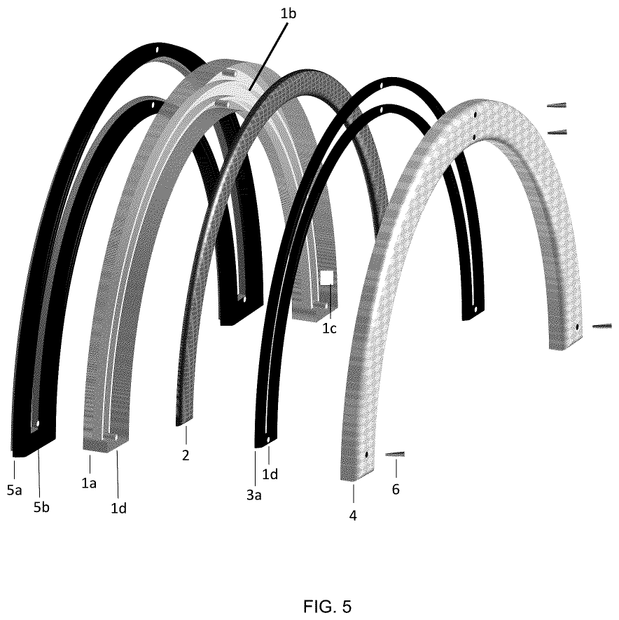

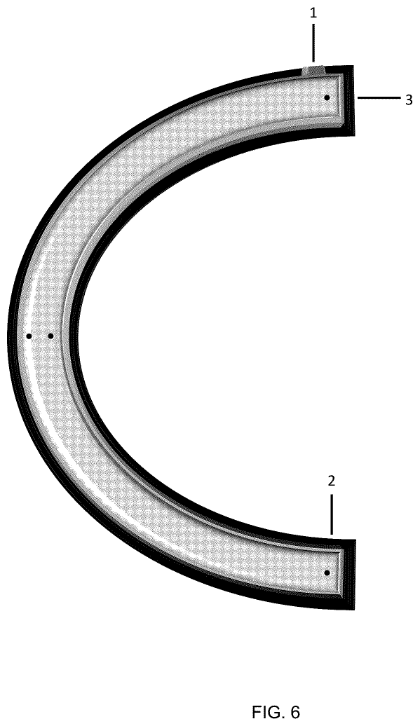

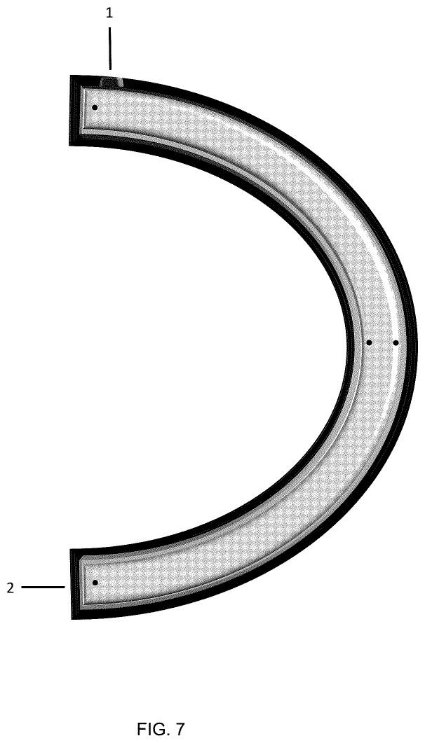

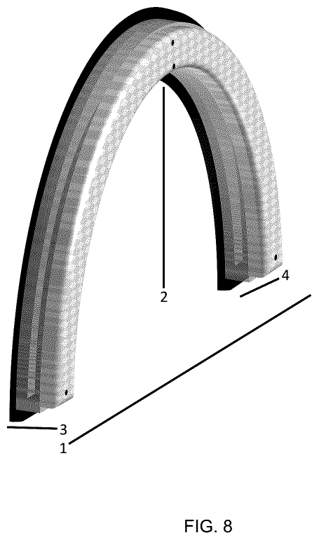

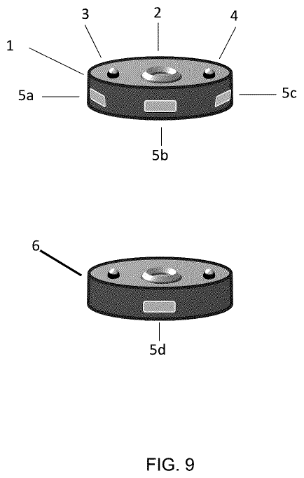

Reference the NUMBERS in FIG. 1: 1a, Plastic Housing; 1b, Rubber Seal affixed inside the Housing; 1c, the opening that reveals the Sensor Chip affixed to the Back of the LED Panel; 1d, Six Screw Holes.

Reference the NUMBERS in FIG. 1: 2, LED Panel with 18 LED Lights Programed to blink 2 Lights at a time in a U Formation will sit on the Rubber seal affixed inside the Housing.

Reference the NUMBERS in FIG. 1: 3, is a Rubber Gasket that hold in-place the LED Panel before attached Lens Cover.

Reference the NUMBERS in FIG. 1: 4, Lens Cover.

Reference the NUMBERS in FIG. 1: 5, the Rubber Seal that attaches to the Outer Lens Cover and to the Inside Front slash Back Windows of Motor Vehicles.

Reference the NUMBERS in FIG. 1: 6, showing the 6 Screws needed to attach numbers 1 thru 5.

FIG. 2 is a Front View of the U-TURN SIGNAL for the Front Windows

FIG. 2: 1a, showing the Black Part of the Outer Rubber-Seal that affix around the LENS Cover.

FIG. 2: 1b, showing the Gray Adhesive Part of the Outer Rubber-Seal that attaches to the Inside Front Windows of all Motor Vehicles.

FIG. 2: 2, points to where the LED Lights starts to Blink in a “U” Formation.

FIG. 3 Shows an Inverted Front View of the U-turn Signal for the Back Windows.

FIG. 3: 1a, showing the Black Part of the Outer Rubber-Seal that affix around the LENS Cover.

FIG. 3: 1b, showing the Gray Adhesive Part of the Outer Rubber-Seal that attaches to the Inside Back Windows of all Motor Vehicles.

FIG. 3: 2, points to where the LED Lights starts to Blink in a “U” Formation.

FIG. 4 Parallel Off Axis 2: Right Front View of a completely assembled Wireless Remote-Control U-turn Signals for the Front and Back windows.

FIG. 4: 1, reveal the Length of 8 Inches.

FIG. 4: 2, reveal the Height of 5 Inches.

FIG. 4: 3, reveal the Width of ¾ Inch.

FIG. 4: 4, reveal the Length of 1 Inch.

Reference the numbers in FIG. 5: 1a, Plastic Housing; 1b, Rubber Seal affixed inside the Housing; 1c, the opening that reveals the Sensor Chip attached to the LED Panel; 1d, Four Screw Holes.

Reference the numbers in FIG. 5: 2, LED Panel with 9 LED Lights Programed to blink 1 Light at a time in a U Formation will sit on the Rubber seal affixed inside the Housing.

Reference the numbers in FIG. 5: 3, is a Rubber Gasket that hold in-place the LED Panel before attached the Lens Cover.

Reference the numbers in FIG. 5: 4, Lens Cover.

Reference the numbers in FIG. 5: 5, the Rubber Seal that attaches to the Housing and to the Front Fenders.

Reference the NUMBERS in FIG. 5: 6, showing the 4 Screws needed to attach numbers 1, thru 5.

FIG. 6 is a Front Top Up View of the U-TURN SIGNAL for the Front Left Fenders.

Reference the NUMBERS in FIG. 6: 1, showing the Sensor Chip attached to the LED Panel.

Reference the NUMBERS in FIG. 6: 2, showing the Black Part of the Outer Rubber-Seal that affix around the Housing.

Reference the NUMBERS in FIG. 6: 3, points to where the LED Lights starts to Blink in a “U” Formation.

FIG. 7 is a Front Top Up View of the U-TURN SIGNAL for the Front Left Fenders.

Reference the NUMBERS in FIG. 7: 1, showing the Sensor Chip attached to the LED Panel.

Reference the NUMBERS in FIG. 7: 2, points to where the LED Lights starts to Blink in a “U” Formation.

FIG. 8: Parallel Off Axis 2: Right Angle view of a completely assembled Wireless Remote-Control U-turn Signals for the Front Fenders.

Reference the numbers in FIG. 8: 1, reveal the Length of 8 Inches.

Reference the numbers in FIG. 8: 2, reveal the Height of 3 Inches.

Reference the numbers in FIG. 8: 3, reveal the Width of 1 Inch.

Reference the numbers in FIG. 8: 4, reveal the Length of 1 Inch.

FIG. 9 shows a Prospective Above Front and Back Views of the Wireless Signal-pod that Activates the 4 U-turn Signals.

Reference the numbers in FIG. 9: 1, a Front view of the Wireless Remote Signal-pod, the side facing the front inside window.

Reference the numbers in FIG. 9: 2, Activation Button Programed to make all 4 U-turn Signals blink in a U-Formation.

Reference the numbers in FIG. 9: 3, a Red LED Light indicates your Battery need replaced.

Reference the numbers in FIG. 9: 4, a Green LED Light (when ON) indicates your Battery is Good.

Reference the numbers in FIG. 9: 5a, Sensor that Activates the U-turn Signal attached to Front Right Fender.

Reference the numbers in FIG. 9: 5b, Sensor that Activates the U-turn Signal attached to Front Inside Window.

Reference the numbers in FIG. 9: 5c, Sensor that Activates the U-turn Signal attached to Front Left Fender.

Reference the numbers in FIG. 9: 5d, Sensor that Activates the U-turn Signal attached to the Back Inside Window.

Reference the numbers in FIG. 9: 6, showing a back view of the Wireless Signal-pod

### DETAILED DESCRIPTION OF THE INVENTION

According to Law, all motored vehicles have a Right and Left Turn Signals. But never a U-turn Signal!

Most motorist make U-turns every day and the only U-turn indicator that let us Motorist and Pedestrians know it is okay to make a U-turn is the “U-TURN SIGNS” displayed at certain intersections.

The U-TURN SIGNS don't let surrounding motorist or pedestrians know which motorist is making a U-turn in the left turning lane at the intersection—UNTIL NOW!

The Wireless Remote-Control U-turn Signal System is the first and only documented U-turn Signal System for Motor Vehicles.

The Wireless Remote-Control U-turn Signal System is comprised of 4 U-turn Signals and 1-Wireless Signal-pod programed to Activate 4 U-turn Signals to Blink in a U formation.

The Wireless Remote-Control U-turn Signal System works like the Right and Left Turn Signals installed on all motored vehicles, it will Illuminates the Intersections with hopes of alerting surrounding motorist and pedestrians of our intended direction while making a U-turn.

The Wireless Remote-Control U-turn Signal System, when attached to motored vehicles, will be the first realistic method of acknowledging a legal U-turn from a motorist while making U-turns.

The Wireless Remote-Control U-turn Signal System, when attached, will illustrate how the U-turn Signals should look on old and new motor vehicles.

The Wireless Remote-Control U-turn Signal for the Front Windows of Motor Vehicles, will attached to the inside front Windows around the rearview mirror Housing, and the only tool needed is a 12-inch Leveler.

The Wireless Remote-Control U-turn Signal for the Front Windows will not obstruct the Motorist view, because it in alignment with the Rearview Mirror.

Wireless Remote-Control U-turn Signal LED Panel for the Front Windows have 18 LED Lights Blinking 2 Lights per Blink in a “U” Formation, starting from the Top Left to the Top Right of the U-turn Signal for the Front Windows.

The Wireless Remote-Control U-turn Signal for the Back Windows of Motor Vehicles, will attach to the Back Windows adjacent or around the existing Break-Lights installed inside the upper-centered part of the Back Windows and the only tool needed is a 12-inch Leveler.

The Wireless Remote-Control U-turn Signal for the Back Windows will not obstruct the Motorist view, because it in alignment with the existing Brake Lights.

Wireless Remote-Control U-turn Signal LED Panel for the Back Windows have 18 LED Lights Blinking 2 Lights per Blink in a “U” Formation, starting from the Bottom Right to the Bottom Left of the U-turn Signal for the Back Windows.

The Wireless Remote-Control U-turn Signal for the Front Left Fenders will like a “U” rotated 90-degrees to the Left.

The Wireless Remote-Control U-turn Signal LED Panel for the Front Left Fenders have 9 LED Lights blinking 1 light per blink in a “U” Formation, starting from the Top to the Bottom of the U-turn Signal for the Left Fenders.

The Wireless Remote-Control U-turn Signal for the Front Right Fenders will like a “U” rotated 90-degrees to the Right.

The Wireless Remote-Control U-turn Signal LED Panel for the Front Right Fenders have 9 LED Lights Blinking 1 Light per Blink in a “U” Formation, starting from the Bottom to the Top of the U-turn Signal for the Right Fenders.

The Wireless Remote Signal-pod will attach to the Dashboard, when activated, all 4 U-turn Signals will blink in a “U” Formation simultaneously.

I claim:

1. The Wireless Remote-Control U-turn Signal System is the first and only U-turn Signal System for Motor Vehicles.

2. The Wireless Remote-Control U-turn Signal System is comprised of 1-Wireless Signal-pod and 4 U-turn Signals.

3. The Wireless Remote-Control U-turn Signal System works like the Right/Left turn signals installed on all motored vehicles, it illuminates the intersections with the hopes of alerting surrounding motorist and pedestrians of the intended direction of the motorist.

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)
